(19) United States
(12) Patent Application Publication
(10) Pub. No.: US 2017/0054533 A1
(43) Pub. Date: Feb. 23, 2017

(54) OPTIMIZATION OF BIT ERROR RATE PERFORMANCE OF HIGH ORDER MODULATED OPTICAL SIGNALS HAVING SIGNAL-DEPENDENT NOISE

(71) Applicant: MULTIPHY LTD., Ness-Ziona (IL)

(72) Inventors: Eduard SONKIN, Rehovot (IL); Gilad KATZ, Shdema (IL); Dan SADOT, Kfar Bilu (IL); Or VIDAL, Kfar-Yona (IL)

(73) Assignee: MULTIPHY LTD., Ness-Ziona (IL)

(21) Appl. No.: 15/242,502

(22) Filed: Aug. 20, 2016

Related U.S. Application Data
(60) Provisional application No. 62/207,949, filed on Aug. 21, 2015.

(51) Int. Cl. H04L 5/00; H04L 1/20

(52) U.S. Cl. CPC H04L 5/006; H04L 1/20

(57) ABSTRACT

An optical modulator with a region with non-linear characteristics with optimized BER performance, which comprises circuitry for adjusting the spacing between power levels of optical signals at the output of the optical modulator by adjusting the bias point of the optical modulator to be closer to a nonlinear region of the modulator, such that modulating signals having lower power will be compressed by the nonlinear region more than modulating signals having higher power. During adjustment, larger spacing between higher power levels of optical signals is introduced at the output of the optical modulator and lower spacing between lower power levels of optical signals is introduced at the output of the optical modulator.

### CROSS-REFERENCE TO RELATED APPLICATION

This application claims the benefit of U.S. Provisional Application No. 62/207,949, filed Aug. 21, 2015, the disclosure of which is incorporated herein by reference in its entirety.

### FIELD OF THE INVENTION

The present invention relates to the field of optical communication systems. More particularly, the invention relates to a method for optimizing the Bit Error Rate (BER) performance of a transmitted signal with multiple levels (e.g. PAM4), for maximizing signal to noise ratio in various channel conditions.

### BACKGROUND OF THE INVENTION

Optical communication systems are subject to various types of impairments. A prominent impairment is signal-dependent noise, where high power levels are received with high noise while low power levels are received with low noise. Signal-dependent noise may originate from the modulator (due to nonlinearities) or from other components in an optical communication channel, such as optical amplifiers, which are used to amplify the modulated signals.

Typical examples of signal-dependent noise include Relative Intensity Noise (RIN—which describes the instability in the power level of a laser source), Amplified Spontaneous Emission (ASE—the light produced by spontaneous emission, that has been optically amplified by the process of stimulated emission in a gain medium) in optically amplified systems, and shot noise (that results from unavoidable random statistical fluctuations of the electric current when the charge carriers, such as electrons, traverse a gap).

FIG. 1 (prior art) presents an exemplary histogram of a 4-way Pulse Amplitude Modulation (PAM4) signal, where the power levels, associated with the PAM4 symbols are equally spaced, while the signal dependent noise dominates. It can be seen that the conditional Probability Density Function (PDF which characterize the probability distribution of a continuous random variable) of high level power contains higher variance compared to lower level power. Consequently, the symbols associated with the high level power (i.e. 13 and 14) are subject to more errors than the symbols associated with the low level power (i.e., 11 and 12), which results in suboptimum Bit Error Rate (BER) performance.

Optimization of the BER performance in such case of signal-dependent noise may be achieved by power level spacing optimization.

It is therefore an object of the present invention to lower signal-dependent noise in a multiple level optical communications signal by optimizing power level spacing.

Other objects and advantages of this invention will become apparent as the description proceeds.

### SUMMARY OF THE INVENTION

The present invention is directed to a method for optimizing BER performance in an optical modulator (such as a Mach-Zehnder Modulator, an Electro-absorption Modulation Laser or a Directly Modulated Laser) with a region with non-linear characteristics, according to which the spacing between power levels of optical signals at the output of the optical modulator is optimized by adjusting the bias point of the optical modulator to be closer to a nonlinear region of the modulator, such that modulating signals with lower power will be compressed by the nonlinear region more than modulating signals with higher power. As a result, larger spacing is introduced between higher power levels of optical signals at the output of the optical modulator and lower spacing is introduced between lower power levels of optical signals at the output of the optical modulator.

After optimization, the Symbol Error Rate (SER) at high power levels will similar to SER at low power levels.

In one embodiment, the DC level of the optical signal is minimized to reduce the required optical transmitted power.

The useful portion of the optical signal may be maximized by maximizing the extinction ratio.

Whenever the nonlinearity characteristics of the optical modulator in its nonlinear region is not insufficient for optimization, non-linear transmission may be performed by introducing, at the input of the optical modulator, smaller spacing between lower power levels of modulating signals and larger spacing between higher power levels of modulating signals.

Non-linear distortions may be compensated by using a non-linear equalizer, such as an MLSE.

The present invention is also directed to an optical modulator with a region with non-linear characteristics with optimized BER performance, which comprises circuitry for adjusting the spacing between power levels of optical signals at the output of the optical modulator by adjusting the bias point of the optical modulator to be closer to a nonlinear region of the modulator, such that modulating signals with lower power will be compressed by the nonlinear region more than modulating signals with higher power.

The optical modulator may be a Mach-Zehnder Modulator (MZM), an Electro-absorption Modulation Laser (EML) or a Directly Modulated Laser (DML).

Smaller spacing between lower power levels of modulating signals and larger spacing between higher power levels of modulating signals may be introduced at the input.

The optical modulator may further comprise a non-linear equalizer, such as an MLSE, for compensating non-linear distortions.

### BRIEF DESCRIPTION OF THE DRAWINGS

In the drawings:

FIG. 1 (prior art) presents an exemplary histogram of a 4-way Pulse Amplitude Modulation (PAM4) signal, where the power levels, associated with the PAM4 symbols, are equally spaced, while the signal dependent noise dominates;

FIGS. 2a and 2b present typical light power vs. applied voltage curves of an MZM;

FIG. 3a shows an eye diagram for evenly spaced power levels;

FIG. 3b shows an eye diagram for unevenly spaced power levels;

FIG. 4 shows preliminary results of BER curves vs. received optical power for different bias points (thus different extinction ratio levels).

### DETAILED DESCRIPTION OF THE INVENTION

The present invention introduces a method for optimizing general performance of an optical communication link over the following dimensions:
a. electrical signal power;
b. optical signal power;
c. noise power and statistical distribution; and
d. transmitter non-linearity.

According to the present invention, a method for reducing signal-dependent noise in a multiple level optical communication signal is proposed. The reduction is achieved by introducing larger spacing between the higher power levels while introducing lower spacing between the lower power levels, so that the Symbols' Error Rate (SER—the error associated with the symbols) at the higher levels will be similar to the SER at low levels.

It is well known that the input-to-output transfer function of optical modulators is commonly nonlinear. This nonlinearity of the optical modulator can be utilized in a beneficial way to achieve both (1) intensity spacing optimization, in order to reduce the impact of signal dependent noise, and (2) in order to reduce the transmitted optical power while maintaining the same sensitivity, thus saving energy.

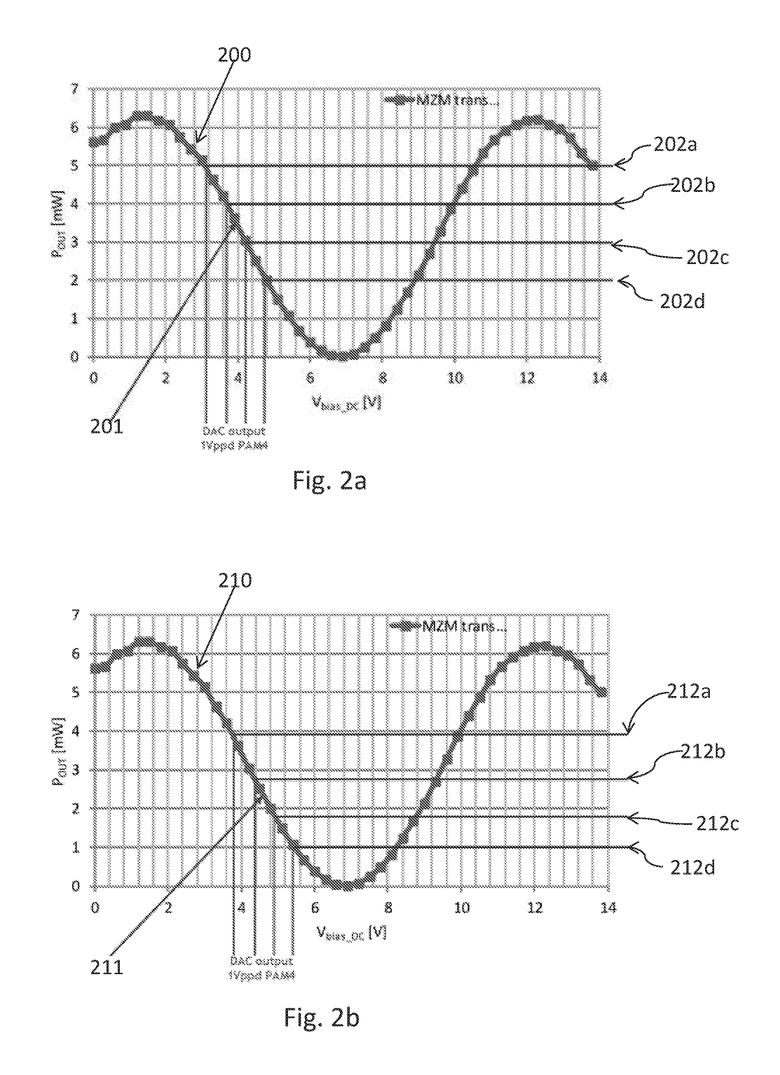

A typical example of a commonly used optical modulator is the Mach-Zehnder Modulator (MZM), which has non-linear (a sine-wave like) characteristics. FIGS. 2a and 2b present typical L/V (light vs. applied voltage) curves 200 and 210 of an MZM. Other optical modulators such as an Electro-absorption Modulation Laser (EML—a semiconductor device which can be used for modulating the intensity of a laser beam via an electric voltage, based on a change in the absorption spectrum caused by an applied electric field, which changes the bandgap energy) or a Directly Modulated Laser (DML) can be used, as well.

FIG. 2a shows the evenly spaced output optical signals (202a-202d) of the linear regime associated with a bias point of 3.8V (point 201) on the bias voltage axis V_{bias-DC}. It can be seen that the bias point (around which the output optical signals are generated from the DAC's output voltages) of 3.8V (201) is located around the more linear region of the MZM's transfer function and therefore, the resulting spacing between the power levels 202a-202d (which correspond to DAC's output voltages that enter the modulator) is even. In this example, the power levels of output optical signals 202a-202d are 5 mW, 4 mW, 3 mW and 2 mW, respectively, with an even spacing of 1 mW. This gives a total optical power of 5+4+3+2=14 mW.

FIG. 2b shown the unevenly spaced output signals (212a-212d) of the nonlinear regime, associated with a higher voltage bias point of 4.6V (211). It can be seen that the bias point of 4.6V (211) is located around the less linear region of the MZM's transfer function and therefore, the resulting spacing between the power levels 212a-212d (which correspond to DAC's output voltages that enter the modulator around the new bias point) is uneven. In this example, the bias point of 4.6V pushes the higher levels more into the non-linear region, such that they are essentially “compressed”. The resulting power levels of output optical signals 212a-212d are 3.9 mW, 2.7 mW, 1.7 mW and 1 mW, respectively, with descending uneven spacing of 1.2 mW, 1 mW and 0.8 mW. This gives a total optical power of 3.9+2.7+1.7+1=9.3 mW.

It can be seen from FIG. 2b that the nonlinearity of the modulator is exploited to reduce the total power level of the modulated optical signal from 14 mW to 9.3 mW. Since the total power of the optical signal has been reduced, the noise power (which depends from the signal power) has been reduced, as well.

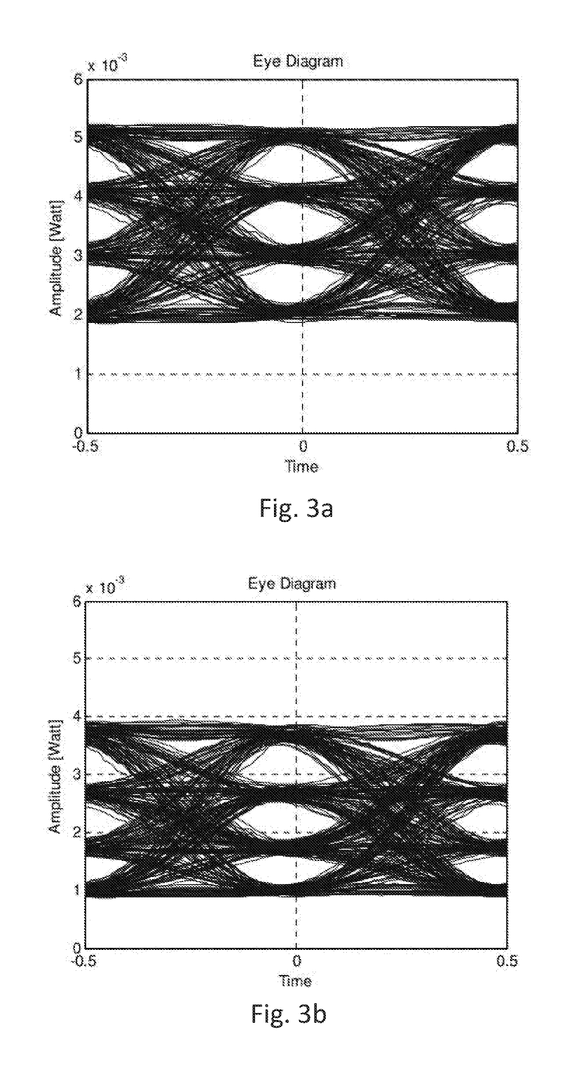

The associated eye diagrams of each of the two transmission schemes 200 and 210 with the two different bias points 201 and 211 of FIG. 2a and FIG. 2b are shown in FIG. 3a and FIG. 3b, respectively. The evenly spaced power levels can be seen in FIG. 3a, while the unevenly spaced power levels can be seen in FIG. 3b.

In an embodiment of the present invention, the DC level of the optical signal is minimized to reduce the non-useful portion of the optical signal, thus minimizing the required optical transmitted power.

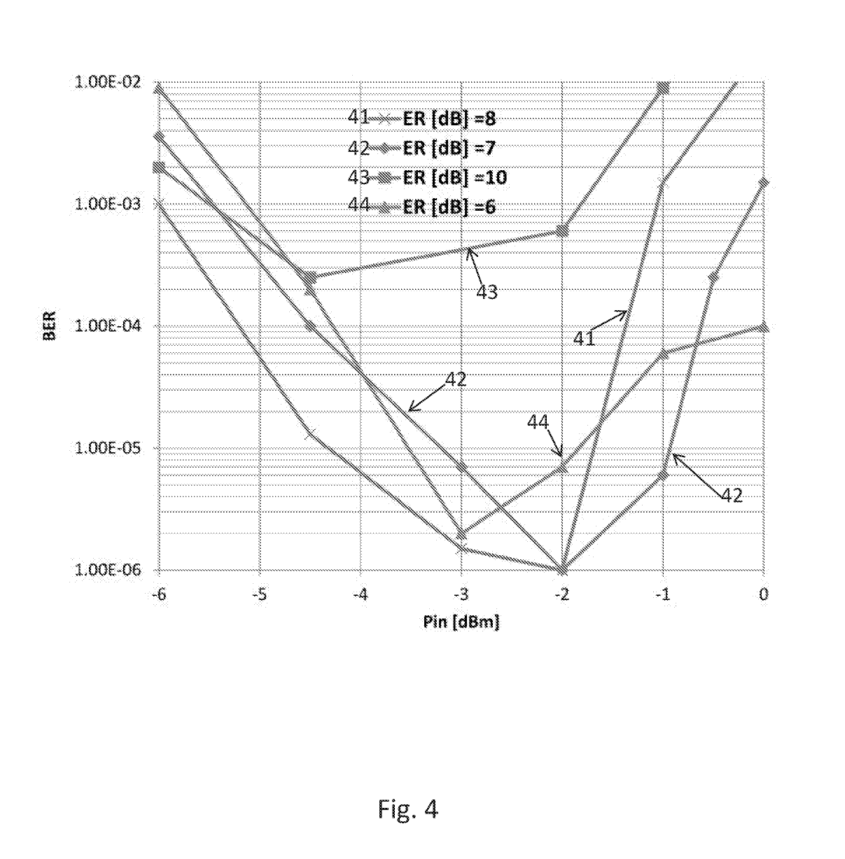

In an experiment, three types of electrical equalizers were considered: Feed Forward Equalizer (FFE), Decision Feedback Equalizer (DFE) and Maximum Likelihood Sequence Estimation (MLSE). The combination of these three equalizers was used in order to perform a quantitative demonstration of the proposed optimization scheme. A set of off-line experiments with a full optical link was performed. Preliminary results are depicted in FIG. 4, where plots 41-44 of BER curves vs. received optical power are presented for different bias points (thus different extinction ratio levels). It is shown that the best results, plot 42, are achieved while using an extinction ratio of 7 dB, corresponding to a bias point of 4.8V, which is within the non-linear regime of the MZM curve of FIG. 2b.

It has been shown that the method described herein of unevenly spacing the power levels of a multi-level transmission signal efficiently optimizes the BER performance in case of signal-dependent noise.

According to another embodiment, if the optical modulator in its nonlinear region is not insufficient for optimization (i.e., optical modulator has more linear characteristics), the modulating signals at the input to the modulator are adjusted such that the spacing between voltages of the modulating signals will be uneven, i.e., lower at lower voltages and will increase for higher voltages of the modulating signals. This is actually a kind of transmitting nonlinearly. For example, if there are 4 levels of modulating signals 0.25V, 0.5V, 0.75V and 1V, the nonlinearity is created digitally at the input to the optical modulator by converting the values to be 0.2V, 0.6V, 0.9V and 1V.

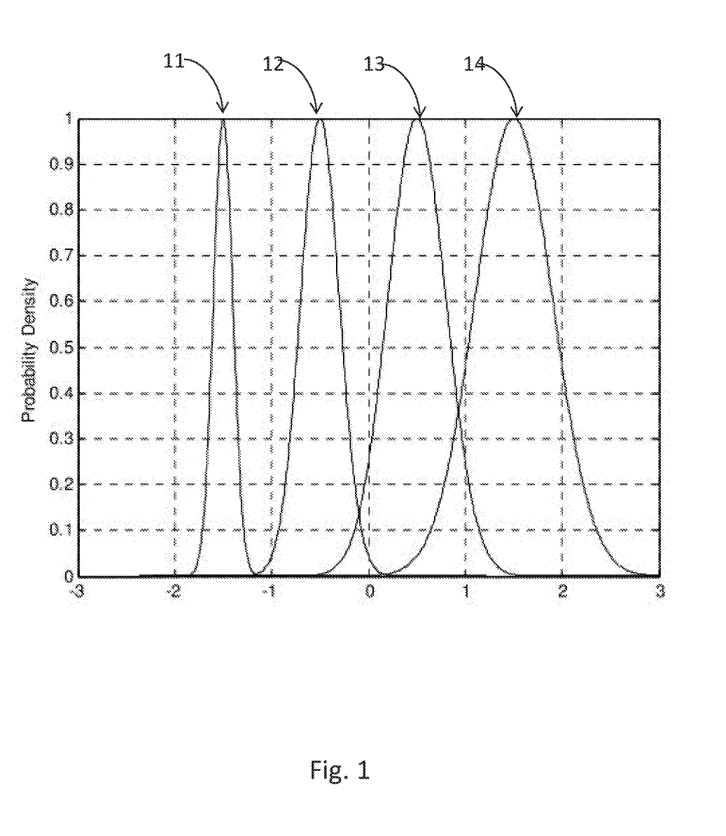

Either ways, the nonlinearity is used to compensate the effect (shown in FIG. 1) that symbols associated with the higher level powers are subject to more errors than the symbols associated with the lower level powers.

In general, digital optical communication systems transmit binary data using two levels of optical power, where the higher power level represents a binary 1 and the lower power level represents a binary 0. The ratio between the “1” level and the “0” level is defined as the “extinction ratio”. The useful portion of the optical signal may be maximized by maximizing this extinction ratio.

As various embodiments have been described and illustrated, it should be understood that variations will be apparent to one skilled in the art without departing from the principles herein. Accordingly, the invention is not to be limited to the specific embodiments described and illustrated in the drawings.

1. A method for optimizing BER performance in an optical modulator having a region with non-linear characteristics, comprising:
a) optimizing the spacing between power levels of optical signals at the output of said optical modulator by:
a.1) adjusting the bias point of said optical modulator to be closer to a nonlinear region of said modulator, such that:
modulating signals having lower power will be compressed by the nonlinear region more than modulating signals having higher power, thereby:
a.2) introducing larger spacing between higher power levels of optical signals at the output of said optical modulator; and
a.3) introducing lower spacing between lower power levels of optical signals at the output of said optical modulator.

2. The method of claim 1, wherein the Symbol Error Rate (SER) at high power levels is similar to SER at low power levels.

3. The method of claim 1, wherein the DC level of the optical signal is minimized to reduce the required optical transmitted power.

4. The method of claim 1, wherein the optical modulator is selected from the group of:
a Mach-Zehnder Modulator (MZM);
an Electro-absorption Modulation Laser (EML);
a Directly Modulated Laser (DML).

5. The method of claim 1, wherein the useful portion of the optical signal is maximized by maximizing the extinction ratio.

6. The method of claim 1, further comprising transmitting non-linearly whenever the nonlinearity characteristics of the optical modulator in its nonlinear region is not insufficient for optimization, by introducing, at the input of the optical modulator, smaller spacing between lower power levels of modulating signals and larger spacing between higher power levels of modulating signals.

7. The method of claim 1, further comprising compensating non-linear distortions by using a non-linear equalizer, such as an MLSE.

8. An optical modulator having a region with non-linear characteristics with optimized BER performance, comprising:
a) circuitry for adjusting the spacing between power levels of optical signals at the output of said optical modulator by adjusting the bias point of said optical modulator to be closer to a nonlinear region of said modulator, such that modulating signals having lower power will be compressed by the nonlinear region more than modulating signals having higher power.

9. An optical modulator according to claim 8, in which larger spacing are introduced between higher power levels of optical signals at the output of said optical modulator and lower spacing are introduced between lower power levels of optical signals at the output of said optical modulator.

10. An optical modulator according to claim 8, in which the DC level of the optical signal is minimized to reduce the required optical transmitted power.

11. An optical modulator according to claim 8, selected from the group of:
a Mach-Zehnder Modulator (MZM);
an Electro-absorption Modulation Laser (EML);
a Directly Modulated Laser (DML).

12. An optical modulator according to claim 8, in which the useful portion of the optical signal is maximized by maximizing the extinction ratio.

13. An optical modulator according to claim 8, in which smaller spacing between lower power levels of modulating signals and larger spacing between higher power levels of modulating signals are introduced at the input.

14. An optical modulator according to claim 8, further comprising a non-linear equalizer, such as an MLSE, for compensating non-linear distortions.
